(19) United States
(12) Patent Application Publication
(10) Pub. No.: US 2016/0180087 A1
(43) Pub. Date: Jun. 23, 2016

(54) SYSTEMS AND METHODS FOR MALWARE DETECTION AND REMEDIATION

(71) Applicants: Jonathan L. Edwards, Portland, OR (US); Joel R. Spurlock, Newberg, OR (US); Aditya Kapoor, Beaverton, OR (US); James Bean, Santa Clara, CA (US); Cedric Cochin, Portland, OR (US); Craig D. Schmugar, Hillsboro, OR (US)

(72) Inventors: Jonathan L. Edwards, Portland, OR (US); Joel R. Spurlock, Newberg, OR (US); Aditya Kapoor, Beaverton, OR (US); James Bean, Santa Clara, CA (US); Cedric Cochin, Portland, OR (US); Craig D. Schmugar, Hillsboro, OR (US)

(21) Appl. No.: 14/580,784

(22) Filed: Dec. 23, 2014

(51) Int. Cl. G06F 21/56

(52) U.S. Cl. CPC G06F 21/561; G06F 21/566

(57) ABSTRACT

Provided in some embodiments are systems and methods for remediating malware. Embodiments include receiving (from a process) a request to access data, determining that the process is an unknown process, providing the process with access to one or more data tokens in response to determining that the process is an unknown process, determining whether the process is engaging in suspicious activity with the one or more data tokens, and inhibiting execution of the process in response to determining that the process is engaging in suspicious activity with the one or more data tokens.

### TECHNICAL FIELD

This application relates generally to computer security and malware protection and, more particularly, to systems and methods for malware detection and remediation based on process interactions with data.

### BACKGROUND

Malware, short for malicious software, includes software used to disrupt computer operation, gather sensitive information, or gain access to private computer systems. It can appear in the form of executable code, scripts, active content, and other software. The term “malware” is used to refer to a variety of forms of hostile or intrusive software, such as computer viruses, worms, trojan horses, ransomware, spyware, adware, scareware, and the like. Ransomware refers to a type of malware that restricts access to the computer system that it infects, and typically demands that a ransom be paid in order for the restriction to be removed. For example, ransomware may lock (e.g., encrypt) files on a user's computer such that they cannot access the files, and demand that the user pay money to have the ransomware unlock (e.g., decrypt) the files. A ransomware program typically propagates as a trojan like a conventional computer worm, entering a system through, for example, a downloaded file or a vulnerability in a network service. The program may then run a payload, such as an executable process that encrypts or otherwise prevents access to files on the system.

Software such as anti-virus, anti-malware, and firewalls are employed by home users and organizations to try to safeguard against malware attacks. Anti-malware software applications may scan systems, for example, to locate malware residing on the system and monitor processes for suspicious activity. Such an application may flag, remove, or otherwise inhibit known malware and suspicious processes. Unfortunately, despite continued efforts to stop the proliferation of malware, different forms of malware continue to evolve. Accordingly, there is a desire to provide tools that can detect and remediate malware to further inhibit the spread of malware.

### BRIEF DESCRIPTION OF THE DRAWINGS

FIG. 1 is a block diagram that illustrates an example computer network environment in accordance with one or more embodiments.

FIG. 2 is a block diagram that illustrates example malware detection and remediation processes in accordance with one or more embodiments.

FIG. 3 is a flowchart that illustrates an example method of malware detection and remediation in accordance with one or more embodiments.

FIGS. 4A-4C are diagrams that illustrate example honey token data in accordance with one or more embodiments.

While the embodiments are susceptible to various modifications and alternative forms, specific embodiments thereof are shown by way of example in the drawings and will herein be described in detail. The drawings may not be to scale. It should be understood, however, that the drawings and the detailed description thereto are not intended to limit the embodiments to the particular form disclosed, but to the contrary, the intention is to cover all modifications, equivalents, and alternatives falling within the spirit and scope of the present embodiments as defined by the appended claims.

### DETAILED DESCRIPTION

The present embodiments will now be described more fully hereinafter with reference to the accompanying drawings in which example embodiments are shown. Embodiments may, however, be provided in many different forms and should not be construed as limited to the illustrated embodiments set forth herein. Rather, these example embodiments are provided so that this disclosure will be thorough and complete, and will fully convey the scope of the disclosure to those skilled in the art.

As discussed in more detail below, provided in some embodiments are systems and methods for malware detection and remediation based on process interactions with data. In some embodiments, an anti-malware application monitors requests for access to data and, in response to determining that the request originates from an unknown process (e.g., a process that has not been identified as safe (trusted) or unsafe (untrusted)), the anti-malware application provides the requesting process with access to honey tokens along with, or in place of, the data that is responsive to the request. The anti-malware application may, then, monitor the process's interaction with the honey tokens for suspicious activity, such as an attempt to alter or exfiltrate data of the honey tokens. If the process engages in suspicious activity, such as attempting to encrypt one of the honey tokens, the anti-malware application may take remedial action. For example, the anti-malware application may alert a user, and flag, suspend, remove, or otherwise inhibit the suspicious activity and/or the suspicious process.

In some embodiments, a honey token can include data that is intended to entice or bait malicious processes, such as those generated by malware applications, to interact with the honey token in a suspicious manner. A honey token may include, for example, false (or fake) data (e.g., false files, data strings, data values, registry entries, and/or the like) that is intended to entice or bait a malicious process into performing malicious activity on the false data. If malicious activity is performed on one or more honey tokens (e.g., a process attempts to alter or exfiltrate the data of one or more honey tokens), then monitoring of the honey tokens may detect the suspicious activity, and remedial action can be taken. If, for example, an unknown process requests to access files in a user's “My Pictures” file folder, then the data provided in response to the request may include one or more honey token files (e.g., false joint photographic experts group (JPEG) files) that are intended to bait a malicious process into performing its malicious activity on the false image files. If malicious activity is performed on the false image files, then monitoring of the false files may detect the suspicious activity and trigger remedial action, such as termination of the process and removal of an application associated with the process.

In some embodiments, one or more honey tokens can be provided in place of data responsive to a request. If, for example, an unknown process requests to access files in a user's “My Pictures” file folder, then the data provided in response to the request may include one or more honey token image files (e.g., false JPEG files) that are provided in place of the real image files (e.g., real JPEG files) located in the user's “My Pictures” file folder. That is, for example, the data provided in response to the request may include only one or more honey token files provided in place of the real files that would otherwise have been provided in response to the request (see, e.g., FIG. 4A discussed in more detail below).

In some embodiments, one or more honey tokens can be injected into (or combined with) data responsive to a request. If, for example, an unknown process requests to access files in a user's “My Pictures” file folder, then the data provided in response to the request may include one or more honey token image files (e.g., false JPEG files) and one or more of the real image files (e.g., real JPEG files) located in the user's “My Pictures” file folder. That is, for example, the data provided in response to the request may include one or more honey tokens provided along with the real image files located in the user's “My Pictures” file folder.

In some embodiments, one or more honey tokens injected into data responsive to a request can be advanced in a sequence of real data responsive to the request. If, for example, an unknown process requests to access files in a user's “My Pictures” file folder, then the data provided in response to the request may include an enumerated sequence of data that includes one or more honey token image files (e.g., false JPEG files) and one or more of the real image files (e.g., real JPEG files) located in the user's “My Pictures” file folder, and the one or more honey token image files (e.g., the false JPEG files) may precede real image files (e.g., real JPEG files) in the enumerated sequence of data. If the user's “My Pictures” file folder includes ten real JPEG files, for example, then an enumerated sequence of data provided in response to the request may include the three honey token JPEG files, followed by the ten real JPEG files located in the user's “My Pictures” file folder. That is, the enumerated sequence of data provided in response to the request may include the following sequence: HT-HT-HT-R-R-R-R-R-R-R-R-R-R, where “HT” represents a honey token image file and “R” represents a real image file (see, e.g., FIG. 4B discussed in more detail below). Thus, the honey tokens may be provided at or near the front of the line of data. Such an embodiment may reveal suspicious activity prior to an unknown process accessing the real files in the sequence. That is, for example, if an unknown process engages in suspicious or malicious activity with any of the three false JPEG files, then the suspicious or malicious activity can be detected and remediated before the unknown process accesses any of the ten real JPEG files that follow in the sequence.

In some embodiments, one or more honey tokens injected into data responsive to a request can be interspersed (or scattered) among a sequence of real data that is responsive to the request. If, for example, an unknown process requests to access files in a user's “My Pictures” file folder, then the data provided in response to the request may include an enumerated sequence of data that includes one or more honey token image files (e.g., false JPEG files) and one or more of the real image files (e.g., real JPEG files) located in the user's “My Pictures” file folder, and the one or more honey token image files (e.g., the false JPEG files) may be scattered among the real image files (e.g., real JPEG files) in the enumerated sequence of data. If, for example, the user's “My Pictures” file folder includes ten real JPEG files, then an enumerated sequence of data provided in response to the request may include a first of the false JPEG files followed by three of the real JPEG files, a second of the false JPEG files followed by four of the real JPEG files, and a third of the false JPEG files followed by the last three of the real JPEG files. That is, the enumerated sequence of data provided in response to the request may include the following sequence: HT-R-R-R-HT-R-R-R-R-HT-R-R-R, where “HT” represents a honey token image file and “R” represents a real image file (see, e.g., FIG. 4C discussed in more detail below). Such an embodiment may reveal suspicious activity prior to the unknown process accessing any of, or at least very many of, the real files and/or may help to detect suspicious activity throughout the sequence of data. That is, for example, if a malicious process has adapted to the inclusion of honey tokens at the beginning of returned sequences of data (e.g., the malicious process knows to ignore the first three files in a returned sequence of data), then the inclusion of honey tokens throughout the sequence of data may still reveal that the malware process is engaging in malicious activity despite the process's attempts to avoid the honey tokens. For example, if the malicious process skips the first three JPEG files (or otherwise does not engage in suspicious activity with the first three JPEG files), but does engage in suspicious activity with the fourth and fifth JPEG file in the sequence (e.g., engages in suspicious activity with the third of the real JPEG files and the second of the honey token JPEG files), then that suspicious activity may be detected and remediated before the malicious process accesses any of the other seven real JPEG files that follow in the sequence. Thus, suspicious activity can be significantly mitigated. In some embodiments, the honey tokens can be interspersed (or scattered) randomly such that it is difficult for a malicious process to detect or predict what is real data and what is false data. This inhibits a malicious process from learning a pattern and adapting to the honey tokens by skipping known locations of the honey tokens.

In some embodiments, honey tokens can have characteristics (e.g., a type, a name, and/or data) that are expected to entice or bait a malicious process into performing its malicious activity on the honey tokens. In some embodiments, a honey token may include a file of a type that is consistent with (e.g., the same or similar to) the type of files expected to be responsive to a corresponding request. For example, if an unknown process requests to access files in a file folder, then a honey token provided in response to the request may include a file of a type that is the same or similar to the types of files typically associated with the file folder. If, for example, an unknown process requests to access files in a user's “My Pictures” file folder, then the data provided in response to the request may include one or more false image files of a type typically associated with users' pictures in the “My Pictures” file folder (e.g., honey token JPEG files, portable document format (PDF) files, tagged image file format (TIFF) files, graphics interchange format (GIF) files, bitmap (BMP) files, raw image format (RAW) files, and/or the like). If, for example, an unknown process requests to access files in a user's “My Music” file folder, then the data provided in response to the request may include one or more false audio files of a type typically associated with users' music in the “My Music” file folder (e.g., honey token MPEG-1 or MPEG-2 audio layer III (MP3) files, waveform audio file format (WAV) files, and/or the like). If, for example, an unknown process requests to access files in a user's “My Documents” file folder, then the data provided in response to the request may include one or more false files of a type typically associated with users' documents in the “My Documents” file folder (e.g., honey token document files, PDF files, text (TXT) files, and/or the like). As a further example, if an unknown process requests to access registry files, then the data provided in response to the request may include one or more false files or other data of a type typically associated with the systems registry (e.g., honey token registry data (DAT) files, registration entry (REG) files, and/or the like).

In some embodiments, a honey token may include a file of a type that is consistent with (e.g., the same or similar to) the type of files identified as being responsive to a corresponding request. For example, if an unknown process requests to access files in a file folder, then a honey token provided in response to the request may include a file having a type that is the same or similar to the types of real files located in the file folder. If, for example, an unknown process requests to access files in a user's “My Pictures” file folder and the “My Pictures” file folder includes only JPEG and TIFF files, then the data provided in response to the request may include honey token JPEG files and honey token TIFF files. That is, for example, the honey tokens may have types based on the types of a user's real files responsive to the request.

In some embodiments, a honey token file may include a name that is consistent with (e.g., the same or similar to) the names of files expected to be provided in response to a request. For example, if an unknown process requests to access files in a file folder, then a honey token provided in response to the request may include a file having a name that is the same or similar to the names of files typically found in the folder. If, for example, an unknown process requests to access files in a user's “My Pictures” file folder, then the data provided in response to the request may include one or more false image files having names that are typically associated with users' photos, such as the files “vacation.jpeg,” “birthday.jpeg,” and/or the like. If, for example, an unknown process requests to access files in a user's “My Music” file folder, then the data provided in response to the request may include one or more false audio files having names that are typically associated with users' music, such as the files “hotel_california.mp3,” “thriller.mp3,” and/or the like. If, for example, an unknown process requests to access files in a user's “My Documents” file folder, then the data provided in response to the request may include one or more false files having names that are typically associated with users' general documents, such as the files “budget.xls,” “report.doc,” “homework.txt,” and/or the like. If, for example, an unknown process requests to access registry files, then the data provided in response to the request may include one or more false files having names that are typically associated with registry files, such as the files “user.dat,” “system.dat,” “classes.dat,” and/or the like.

In some embodiments, a honey token file may include a name that is consistent with (e.g., the same or similar to) the name of files responsive to a corresponding request. For example, if an unknown process requests to access files in a file folder, then a honey token provided in response to the request may include a file having a name that is the same or similar to the names of files found in the folder. If, for example, an unknown process requests to access files in a user's “My Pictures” file folder and the “My Pictures” file folder includes the files “2012_vacation.jpeg,” “mikes_birthday.jpeg,” and/or the like, then the data provided in response to the request may include the honey token files “vacation.jpeg,” “birthday.jpeg,” and/or the like. That is, for example, the honey tokens may have names that are variations of the names of a user's real files.

In some embodiments, a honey token file may include data that is consistent with (e.g., the same or similar to) data expected to be found in files provided in response to a corresponding request. For example, if a honey token is of a given file type, then the honey token file may include data (e.g., strings, values, and/or the like) that is typically associated with the file type and/or that may otherwise be attractive to a malicious process. If, for example, an unknown process requests to access files in a user's “My Documents” file folder, then the data provided in response to the request may include one or more false files typically associated with users' general documents (e.g., honey token document files, PDF files, TXT files, and/or the like), and those honey token files may include data strings (which are typically found in these types of files), suggesting that the documents are of value to the user, such as “important,” “social security number,” “date of birth,” “confidential,” and/or the like.

In some embodiments, a honey token may include data that is consistent with (e.g., the same or similar to) the real data identified as responsive to a corresponding request. For example, if an unknown process requests to access files in a file folder, then a honey token provided in response to the request may include a file having data (e.g., strings, values, and/or the like) that is the same or similar to the data in the files found in the folder. If, for example, an unknown process requests to access files in a user's “My Documents” file folder and document files in the “My Documents” file folder include the text strings “Jane's Recipes,” “Term Paper,” and/or the like, then the data provided in response to the request may include one or more false files typically associated with users' general documents (e.g., honey token document files, PDF files, TXT files, and/or the like) that include the text strings “Jane's Recipes,”, “Term Paper,” and/or the like.

In some embodiments, real files to which an unknown process is provided access can be backed-up. For example, a duplicate copy of the data provided to an unknown process can be maintained at least until the process has completed accessing the data, or the process is determined to be safe (trusted) or otherwise not suspicious. If, for example, an unknown process requests to access files in a user's “My Pictures” file folder, and the data provided in response to the request includes one or more false image files (e.g., honey token JPEG files) and real image files (e.g., real JPEG files from the “My Pictures” file folder), then a duplicate copy of the real image files (e.g., real JPEG files from the “My Pictures” file folder) can be stored as a back-up. If the unknown process is subsequently determined to be a safe (trusted) process (or it is otherwise determined that the real image files were not harmed), the back-up files can be deleted. If the unknown process is subsequently determined to engage in malicious or otherwise suspicious behavior (e.g., altering or deleting the real image files), the back-up files can be used to restore the real image files. For example, if the unknown process is a malicious process that encrypts the real image files to which access was provided in response to the request (such that a user cannot access the real image files) and demands a ransom of $200 to decrypt the real image files, the malicious activity may be detected and remediated, and the now encrypted version of the files can be replaced with the back-up copy of the files.

In some embodiments, suspicious (or malicious) activity can include an activity that is indicative of an effort to harm or otherwise prevent access to data. Suspicious activity can include, for example, altering data (e.g., attempting to modify a file), exfiltrating data (e.g., attempting to copy data from a file), activating is inconsistent with the type of process (e.g., a process that is not associated with reading file contents, attempting to read contents of the file), and/or the like.

In some embodiments, remediation can include inhibiting a suspicious (or malicious) process. Remediation can include, for example, notifying a user of the suspicious activity or process (e.g., via an on-screen prompt), suspending or terminating the suspicious activity of the process (e.g., suspending execution of the process such that it cannot conduct suspicious or malicious activity on other data), restricting rights of the process (e.g., restricting the process's access rights to certain types of data), deleting the process (e.g., removing the process from the system), sandboxing the process (e.g., isolating the execution environment of the process), backing-up potentially vulnerable files (e.g., backing-up files that are the same or similar to those attempting to be accessed by the process), and/or the like. Remediation can include taking similar steps with regard to any other elements (e.g., processes or applications) associated with the suspicious process or suspicious activity, including elements on the local system and/or any other elements (e.g., processes or applications) associated with the malicious process on other systems. For example, if a process is determined to be malicious, or otherwise suspected of malicious behavior on a computer, steps may be taken to remediate the process on the computer, as well as remediate the same or similar processes executing on other computers. This may help to inhibit the proliferation of a malicious process across a computer network, for example.

Accordingly, honey tokens can operate as a “trip-wire” that provides an alert with regard to suspicious activity by one or more processes. For example, when a process engages in suspicious activity with one or more honey tokens, that activity can be detected, and remedial action can be taken. Although certain embodiments are discussed in a certain context, such as a process accessing files in file folders, for the purpose of illustration, embodiments can be employed with any suitable type of data and any suitable data locations.

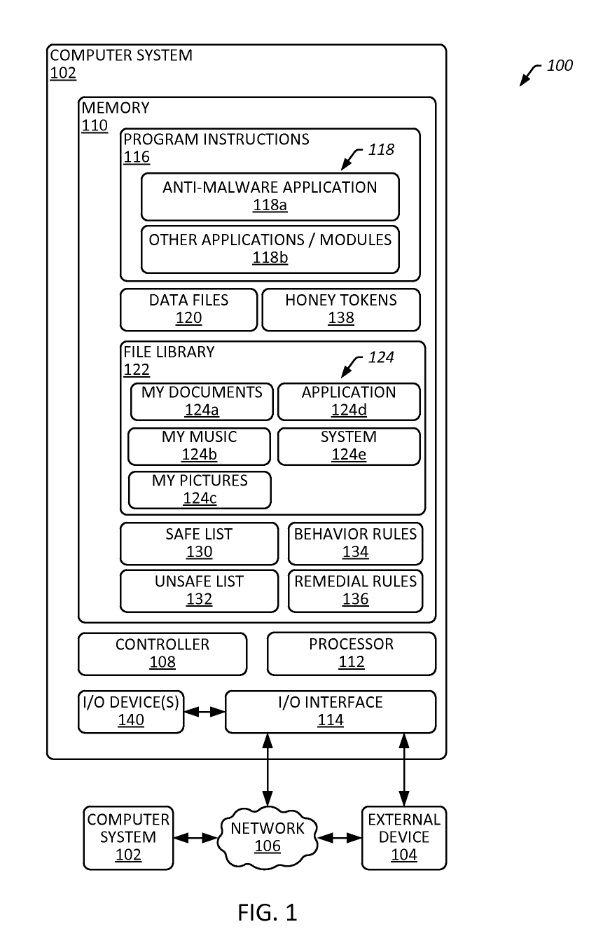

FIG. 1 is a block diagram that illustrates an example computer environment (“environment”) 100 in accordance with one or more embodiments. Environment 100 may include one or more computer systems (or “computer devices”) 102 and/or other external devices 104 communicatively coupled via a communications network (“network”) 106.

The network 106 may include an element or system that facilitates communication between entities of the environment 100. For example, the network 106 may include an electronic communications network, such as the Internet, a local area network (LAN), a wide area network (WAN), a wireless local area network (WLAN), a cellular communications network, and/or the like. In some embodiments, the network 106 can include a single network or a combination of networks.

In some embodiments, a computer system (or “computer device”) 102 can include any variety of computer devices, such as a desktop computer, a laptop computer, a mobile phone (e.g., a smart phone), a server, and/or the like. In some embodiments, a computer system 102 may include a controller 108, a memory 110, a processor 112, and/or an input/output (I/O) interface 114. In some embodiments, the computer system 102 can include a system on a chip (SOC). For example, the computer system 102 may include a SOC that includes some or all of the components of computer system 102 described herein, integrated onto an integrated circuit.

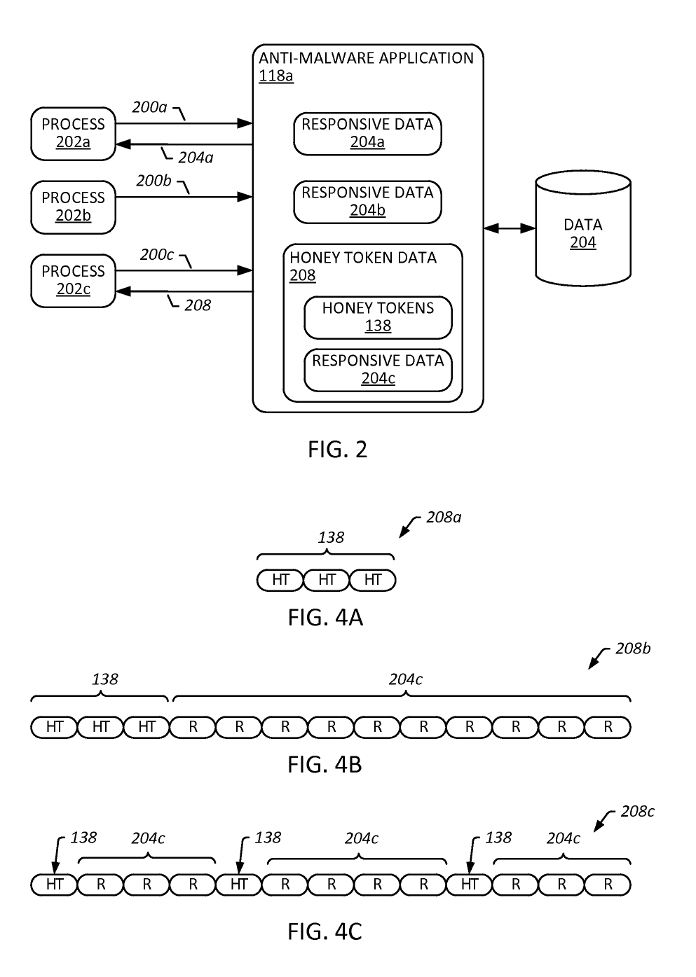

The controller 108 may control communications between various components of the device 102. The memory 110 may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), and/or the like. The memory 110 may include a non-transitory computer-readable storage medium having program instructions 116 stored thereon. The program instructions 116 may be executable by a computer processor (e.g., by the processor 112) to cause functional operations (e.g., methods, routines, or processes). For example, the program instructions 116 may include applications (or program modules) 118 (e.g., subsets of the program instructions 116) that are executable by a computer processor (e.g., the processor 112) to cause the functional operations (e.g., methods, routines, or processes) described herein, including those described with regard to FIG. 2 and the method 300. The applications 118 may include, for example, an anti-malware application 118a and/or one or more other applications/modules 118b (e.g., an electronic mail (“e-mail”) application, a browser application, a gaming application, a media player application, a cloud storage application, and/or the like). As described herein, the anti-malware application 118a can be employed to identify and remediate malware, such as computer viruses, worms, trojan horses, ransomware, spyware, adware, scareware, and/or the like. The other applications/modules 118b may include applications (or modules) that are known to be safe (trusted), applications (or modules) that are known to be unsafe (untrusted), and/or unknown applications (or modules) (e.g., that are not known to be either safe (trusted) or unsafe (untrusted)).

The memory 110 may store data files 120 (or other resources). The data files 120 may include files that can be used by one or more of the applications 118. The data files 120 may be organized in a file library (or database) 122. The file library 122 may include folders 124 including collections (or sets) of data files 120. For example, in an illustrative embodiment, the file library 122 may include a “My Documents” folder 124a (e.g., having a file path “C:\Users\Mike\Libraries\Documents”) for holding general data files 120 for a user (e.g., word processing files (*.doc files), spreadsheet files (*.xls files), text files (*.txt files), and/or the like). The file library 122 may include a “My Music” folder 124b (e.g., having a file path “C:\Users\Mike\Libraries\Music”) for holding music (or audio) data files 120 for a user (e.g., MP3 files (*.mp3 files), WAV files (*.wav files), and/or the like). The file library 122 may include a “My Pictures” folder 124c (e.g., having a file path “C:\Users\Mike\Libraries\Pictures”) for holding picture (or image) data files 120 for a user (e.g., JPEG files (*.jpg files), PDF files (*.pdf files), TIFF files (*.tiff files), GIF files (*.gif files), BMP files (*.bmp files), RAW files, and/or the like). The file library 122 may include one or more application folders 124d (e.g., C:\Program Files\MediaPlayer) for holding data files 120 associated with applications (e.g., executable files (*.exe files), dynamic-link-library (DLL) files (*.dll files), and/or the like). The file library 122 may include a system level folder 124e (e.g., C:\Windows) holding system registry data files 120 (e.g., registry data (DAT) files (*.dat file), registration entry (REG) files (*.reg files), and/or the like).

The memory 110 may store a safe list (trusted list or non-malware list) 130. The safe list 130 may identify files, processes, applications, network locations, and/or like elements that may be known to be free of any association with malware. That is, for example, the safe list 130 may include a listing of one or more “trusted” or “safe” files, processes, applications, network locations, and/or the like that are identified as not conducting or otherwise being associated with suspicious or malicious activity. For example, the safe list 130 may include or otherwise identify a word processing application, a spreadsheet application, an internet browser application, and/or the like that may be known to be free of any association with malware.

The memory 110 may store an unsafe list (untrusted list or malware list) 132. The unsafe list 132 may identify files, processes, applications, network locations, and/or like elements that are known to be associated with malware. That is, for example, the unsafe list 132 may include a listing of one or more processes, applications, network locations, and/or the like that are identified as conducting or otherwise being associated with suspicious or malicious activity. For example, the unsafe list 132 may include a gaming application that is known to alter files, an executable file that is known to be ransomware, a website or a server that attempts to install malware on users' computers, and/or the like.

The memory 110 may store behavioral (or activity) rules 134. The behavior rules 134 may provide rules for monitoring the behavior (or activity) of processes (e.g., scripts, executables, modules, or other elements) to determine whether a process is acting in a suspicious or malicious manner that indicates an association with malware. The behavior rules 134 may also provide rules for classifying or otherwise determining the level of a suspicious activity, such as low threat, moderate threat, and high threat. The behavior rules 134 may define, for example, that altering data (e.g., attempting to modify a file) is a high threat, exfiltrating data (e.g., attempting to copy data from a file) is a moderate threat, and taking activates inconsistent with the type of process (e.g., a process that is not associated with reading file contents, attempting to read contents of a file) is a low threat, and/or the like. Such classification may be used to determine an appropriate course of remedial action, for example.

The memory 110 may store remedial rules 136. The remedial rules 136 may provide rules for determining remedial actions to be taken in response to determining that a process is engaging in a suspicious or malicious manner that indicates an association with malware. The remedial rules 136 may define, for example, that if suspicious behavior is classified as a low threat, then the potentially affected files should be backed-up; if suspicious behavior is classified as a moderate threat, then the offending process should be suspended or terminated; if suspicious behavior is classified as a moderate threat, then the offending process should deleted from the system; and/or the like.

The memory 110 may store honey tokens 138. A honey token 138 may include data that is intended to entice or bait malicious processes, such as those generated by malware applications, to interact with the honey token 138 in a suspicious manner. In some embodiments, the honey tokens 138 may include pre-stored honey tokens 138 and/or may include dynamically generated honey tokens 138 (e.g., honey tokens 138 generated by the anti-malware application 118a in response to a corresponding request).

The processor 112 may be any suitable processor capable of executing/performing program instructions. The processor 112 may include, for example, a central processing unit (CPU) that can execute the program instructions 116 (e.g., execute the program instructions of one or more of the applications 118) to perform arithmetical, logical, and input/output operations described herein. The processor 112 may include one or more processors.

The I/O interface 114 may provide an interface for communication with one or more I/O devices 140, such as computer peripheral devices (e.g., a computer mouse, a keyboard, a display device for presenting a graphical user interface (GUI), a printer, a touch interface (e.g., a touchscreen), a camera (e.g., a digital camera), a speaker, a microphone, an antenna, and/or the like). For example, if the computer system 102 is a mobile phone (e.g., a smart phone), the I/O devices 140 may include an antenna, a speaker, a microphone, a camera, a touchscreen and/or the like. Devices may be connected to the I/O interface 114 via a wired or a wireless connection. The I/O interface 114 may provide an interface for communication with other computer systems 102 (e.g., other computers, servers, and/or the like) and/or one or more other external devices 104 (e.g., external memory, databases, and/or the like). The I/O interface 114 may include a network interface that communicatively couples the computer system 102 to other entities via the network 106.

FIG. 2 is a block diagram that illustrates example malware detection and remediation processes in accordance with one or more embodiments. In some embodiments, the anti-malware application 118a intercepts requests 200 received from processes 202. For example, the anti-malware application 118a may intercept first, second and third requests (or “access requests”) 200a, 200b, and 200c received from first, second, and third processes 202a, 202b, and 202c, respectively. The first process 202a may be associated with a word processing application, and the first access request 200a may include a request to access data files 120 in the “My Documents” folder 124a. The second process 202b may be associated with a gaming application, and the second access request 200b may include a request to access data files 120 in the “My Music” folder 124b. The third process 202c may be associated with a media player application, and the third access request 200c may include a request to access data files 120 in the “My Pictures” folder 124c.

The anti-malware application 118a may determine whether the requesting process 202 (e.g., the source of the access request 200) is a known or unknown process, and if it is a known process, whether it is a safe (or trusted) process (e.g., known to be free of any association with malware) or an unsafe (or untrusted) process (e.g., known to be associated with malware). In some embodiments, the determination of whether a requesting process 202 is a known process, and whether the requesting process 202 is a safe (trusted) process or an unsafe (untrusted) process can be based on a comparison of the requesting process 202 to the elements of the safe list 130 and/or the unsafe list 132. If the requesting process 202 is included on the safe list 130, then the requesting process 202 can be determined to be a known safe process. If the requesting process 202 is included on the unsafe list 132, then the requesting process 202 can be determined to be a known unsafe process. If the requesting process 202 does not appear in either one of the safe list 130 or the unsafe list 132, then the requesting process 202 can be determined to be an unknown process. If, for example, the first process 202a is included on the safe list 130, then the anti-malware application 118a may determine that the first process 202a is a known safe process. If, for example, the second process 202b is included on the unsafe list 132, then the anti-malware application 118a may determine that the second process 202b is a known unsafe process. If, for example, the third process 202c is not included on the safe list 130 and is not included on the unsafe list 132, then the anti-malware application 118a may determine that the third process 202c is an unknown process.

In the event the requesting process 202 is determined to be a known safe process, then the anti-malware application 118a may provide the requesting process 202 with access to the portion of data 204 (e.g., data stored in memory 110) that is responsive to the access request 200. For example, the anti-malware application 118a may supply to the requesting process 202, the portion of the data 204 that is responsive to the access request 200, or otherwise provide the requesting process 202 with access to the portion of the data 204 that is responsive to the access request 200. If, for example, the anti-malware application 118a determines that the first process 202a is a known safe process, then the anti-malware application 118a may provide the first process 202a with access to responsive data 204a that includes the data files 120 in the “My Documents” folder 124a.

In the event the requesting process 202 is determined to be a known unsafe process, the anti-malware application 118a may not provide the requesting process 202 with access to the portion of the data 204 that is responsive to the access request 200. Further, the anti-malware application 118a may take additional remedial action. Taking remedial action may include, for example, notifying a user of the known unsafe process (e.g., via an on-screen prompt), suspending or terminating the known unsafe process (e.g., suspending execution of the process such that it cannot conduct suspicious or malicious activity on other data), restricting rights of the known unsafe process (e.g., restricting the process's access rights to certain types of data), deleting the known unsafe process (e.g., removing the process from the system), sandboxing the known unsafe process (e.g., isolating the execution environment of the process), backing-up potentially vulnerable files (e.g., backing-up files that are the same or similar to those attempting to be accessed by the process), and/or the like. If, for example, the anti-malware application 118a determines that the second process 202b is a known unsafe process, the anti-malware application 118a may block the requesting process 202 from having access to responsive data 204b that includes the data files 120 in the “My Music” folder 124b. Further, the anti-malware application 118a may proceed to generate an on-screen prompt notifying a user of the presence of the known unsafe process 202b (e.g., via an on-screen prompt displayed by the computer system 102), suspend or terminate the known unsafe process 202b, and delete the known unsafe process 202b and related elements from the computer system 102 (e.g., uninstall the gaming application associated with the process 202b).

In the event the requesting process 202 is determined to be an unknown process, the anti-malware application 118a may provide the requesting process 202 with access to honey token data (or modified data) 208. The honey token data 208 may include one or more honey tokens 138. In some embodiments, the honey token data 208 may include one or more honey tokens 138 and at least a portion of the data 204 that is responsive to the access request 200. Thus, the requesting process 202 may be provided access to the honey tokens 138 in place of, or in combination with, the portion of the data 204 that is responsive to the access request 200. In some embodiments, the honey tokens 138 may include pre-stored honey tokens 138 and/or may include dynamically generated honey tokens 138 (e.g., honey tokens 138 generated by the anti-malware application 118a in response to a corresponding access request 200). If, for example, the anti-malware application 118a determines that the third process 202c is an unknown process, the anti-malware application 118a may provide access to honey token data 208 that includes honey tokens 138 provided in place of, or in combination with, responsive data 204c that includes the data files 120 in the “My Pictures” folder 124c.

In some embodiments, the anti-malware application 118a can monitor how the requesting process 202 is using or otherwise interacting with the honey tokens 138 to which it is provided access, to determine whether the requesting process 202 is engaging in suspicious activity with the honey tokens 138 and/or other portions of the honey token data 208. In some embodiments, it can be determined that the requesting process is engaging in suspicious activity if the requesting process takes an action that is consistent with malicious behavior, such as attempting to alter or exfiltrate the data of one or more honey tokens 138. If, for example, the monitoring by the anti-malware application 118a detects that the process 202c is attempting to modify (e.g., attempting to edit, encrypt, or delete) at least one of the honey tokens 138 and/or attempting to exfiltrate data from (e.g., attempting to copy data from) at least one of the honey tokens 1388, then the anti-malware application 118a may determine that the process 202c is engaging in suspicious activity. In some embodiments, the determination of whether the requesting process 202 is engaging in suspicious activity can be based on application of the behavior rules 134. If, for example, the behavior rules 134 specify that an attempt to encrypt a file by a process 202 is suspicious behavior of a high-threat level, then the anti-malware application 118a may determine that the process 202c is engaging in suspicious activity of a high-threat level if monitoring by anti-malware application 118a detects that the process 202c is attempting to encrypt one of the honey tokens 138 of the honey token data 208.

In the event it is determined that a requesting process 202 is not engaging in suspicions activity with the honey tokens 138, the anti-malware application 118a may not take any remedial action. In the event that it is determined that the requesting process 202 is engaging in suspicious or malicious activity with the honey tokens 138, however, the anti-malware application 118a may take remedial action. Taking remedial action may include, for example, notifying a user of the suspicious process (e.g., via an on-screen prompt), suspending or terminating the suspicious process (e.g., suspending execution of the process such that it cannot conduct suspicious or malicious activity on other data), restricting rights of the suspicious process (e.g., restricting the process's access rights to certain types of data), deleting the suspicious process (e.g., removing the process from the system), sandboxing the suspicious process (e.g., isolating the execution environment of the process), backing-up potentially vulnerable files (e.g., backing-up files that are the same or similar to those attempting to be accessed by the process), and/or the like. If, for example, the anti-malware application 118a determines that the process 202c is engaging in suspicious activity, then the anti-malware application 118a may restrict the process's access to the portion of the data 204 that is responsive to the third access request 200c (e.g., the anti-malware application 118a may block the process 202c from accessing responsive data 204c that includes the data files 120 in the “My Pictures” folder 124c). Further, the anti-malware application 118a may proceed to generate an on-screen prompt notifying a user of presence of the suspicious process 202c (e.g., via an on-screen prompt displayed by the computer system 102), suspend or terminate the process 202c, and delete the process 202c (e.g., uninstall the media player application associated with the process 202c) from the computer system 102. In some embodiments, the determination of the type of remedial action can be based on application of the remedial rules 136. If, for example, the remedial rules 136 specify that if suspicious behavior is classified as a high threat, then the offending process should be deleted from the system, and it is determined that the process 202c is engaging in suspicious activity of a high-threat level (e.g., the process 202c is attempting to encrypt one of the honey tokens 138 of the honey token data 208), then the anti-malware application 118a may take remedial action that includes deleting the process 202c and related elements from the computer system 102 (e.g., uninstall the media player application associated with the process 202c).

In some embodiments, taking remedial action can include updating the unsafe list 132. If, for example, it is determined that the process 202c is engaging in suspicious activity (e.g., the process 202c is attempting to encrypt one of the honey tokens 138 of the honey token data 208), then the anti-malware application 118a may update the unsafe list 132 to include the process 202c and the media player application that is associated with the process 202c.

In some embodiments, taking remedial action can include taking similar steps with regard to any other elements (e.g., processes or applications) associated with a process 202 that is engaging in suspicious activity, including those on the local computer system 102 and/or other computer systems 102. If for example, it is determined that the process 202c is engaging in suspicious activity (e.g., the process 202c is attempting to encrypt one of the honey tokens 138 of the honey token data 208), then the anti-malware application 118a may proceed to suspend one or more other processes 202 that are related to the process 202c (e.g., suspending other processes 202 associated with the media player application that is associated with the process 202c), and/or may cause an alert to be sent to another computer system 102 (e.g., an anti-malware server that is tracking proliferation of malware). In such an embodiment, the anti-malware server (e.g., one of the other systems 102) may broadcast information about the offending process 202c to other computer systems 102. For example, the anti-malware server may broadcast an updated unsafe list 132 that includes the process 202c and the media player application that is associated with the process 202c. In some embodiments, the anti-malware server may broadcast various types of updated malware information to clients. For example, the anti-malware server may broadcast an updated unsafe list 132, an updated safe list 130, updated remedial rules 136 and/or updated behavior rules 134. For example, if a process is on the safe list 130 and is not on the unsafe list 132, but is found to be malware, the server may generate and broadcast to one or more client devices (e.g., broadcast to other computer system 102 via the network 106) an updated version of the safe list 130 that does not include the process, and/or an updated version of the unsafe list 132 that does include the process. As a further example, in response to updating the remedial rules 136 and/or the behavioral rules 134 (e.g., based on processes determined as safe or unsafe and/or observed/detected malicious activity by one or more processes), the server may generate and broadcast to one or more client devices an updated version of the remedial rules 136 (e.g., that define an updated set of remedial actions), and/or an updated version of the behavioral rules 134 (e.g., that define an updated set of behavioral rules). The client devices may, for example, use the broadcast information until they receive the next updated version. Thus, the client devices may be provided with and make use of current/updated versions unsafe lists 132, safe lists 130, remedial rules 136 and/or behavior rules 134.

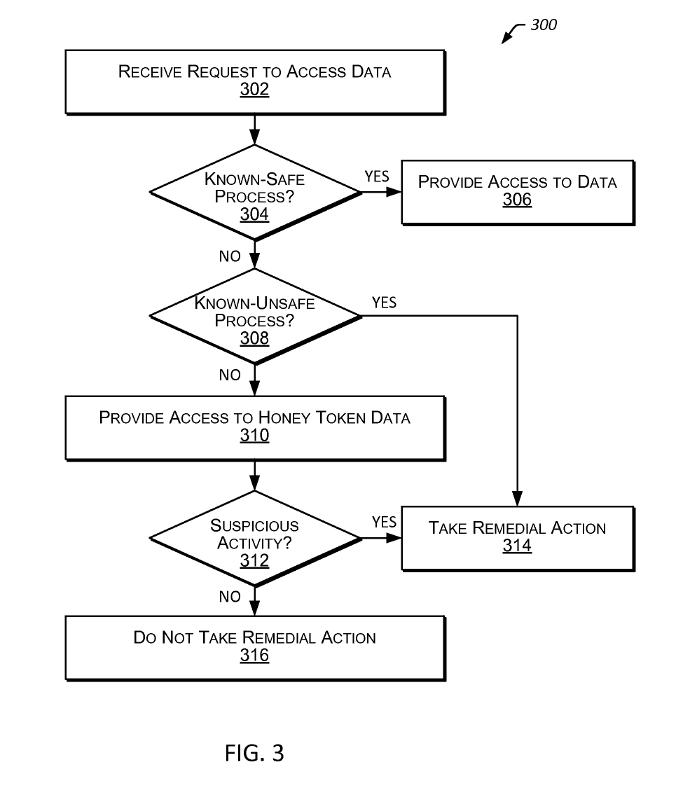

FIG. 3 is a flowchart that illustrates an example method 300 of malware detection in accordance with one or more embodiments. In some embodiments, the method 300 generally includes receiving a request to access to data (block 302) and determining whether the requesting process is a known safe (or known trusted) process (block 304) or a known unsafe (or known untrusted) process (block 308). The method 300 may proceed to providing access to the data (block 306) if the requesting process is determined to be a known safe process. The method 300 may proceed to taking remedial action (block 314) if the requesting process is determined to be a known unsafe process. If the requesting process is unknown (e.g., if the requesting process is determined to be neither a known safe process nor a known unsafe process), the method 300 may proceed providing the requesting process with access to honey token data (block 310) and determining whether the requesting process has engaged in suspicious activity with the honey token data (block 312). The method 300 may proceed to taking remedial action (block 314) if it is determined that the requesting process has engaged in suspicious activity with the honey token data, or not taking remedial action (block 316) if it is not determined that the requesting process has engaged in suspicious activity with the honey token data. In some embodiments, the method 300 may be performed by the anti-malware application 118a and/or other applications/modules 118 of the computer system 102.

In some embodiments, receiving a request to access data (block 302) can include intercepting (or otherwise receiving) one or more access requests 200 from one or more processes 202. For example, the anti-malware application 118a may intercept first, second, and third access requests 200a, 200b, and 200c received from a first, second, and third process 202a, 202b, and 202c, respectively. As discussed above, the first process 202a may be associated with a word processing application, and the first access request 200a may include a request to access data files 120 in the “My Documents” folder 124a. The second process 202b may be associated with a gaming application, and the second access request 200b may include a request to access data files 120 in the “My Music” folder 124b. The third process 202c may be associated with a media player application, and the third access request 200c may include a request to access data files 120 in the “My Pictures” folder 124c. In some embodiments, intercepting an access request 200 can include the processor 112 transmitting an access request 200 to the anti-malware application 118a prior to executing the access request 200. For example, in response to the processor 112 receiving the first, second, and access requests 200a, 200b, and 200c from the first, second, and third processes 202a, 202b, and 202c, respectively, the processor 112 may direct the access requests 200a, 200b, and 200c to the anti-malware application 118a for processing prior to executing the respective access requests 200a, 200b, and 200c (e.g., before providing the processes 202a, 202b, and 202c with the requested access to the corresponding files of the folders 124a, 124b, and 124c).

In some embodiments, determining whether the requesting process is a known safe (or known trusted) process (block 304) or a known unsafe (known untrusted) process can be based on a comparison of the requesting process 202 to the elements listed in the safe list 130 and/or the unsafe list 132. If the requesting process 202 is included on the safe list 130, then the requesting process 202 may be determined to be a known safe process (e.g., the answer is “YES” at block 304). If the requesting process 202 is included on the unsafe list 132, then the requesting process 202 may be determined to be a known unsafe process (e.g., the answer is “NO” at block 304 and “YES” at block 308). If the requesting process 202 does not appear in either one of the safe list 130 or the unsafe list 132, then the requesting process 202 may be determined to be an unknown process (e.g., the answer is “NO” at block 304 and “NO” at block 308). If, for example, the first process 202a is included on the safe list 130, then the anti-malware application 118a may determine that the first process 202a is a known safe process. If, for example, the second process 202b is included on the unsafe list 132, then the anti-malware application 118a may determine that the second process 202b is a known unsafe process. If, for example, the third process 202c is not included on the safe list 130 and is not included on the unsafe list 132, then the anti-malware application 118a may determine that the third process 202c is an unknown process.

In some embodiments, providing access to the data (block 306) can include providing the requesting process 202 with access to the portion of the data 204 that is responsive to the access request 200. For example, the anti-malware application 118a may supply to the requesting process 202, the portion of the data 204 that is responsive to the access request 200, or otherwise provide the requesting process 202 with access to the portion of the data 204 that is responsive to the access request 200. If, for example, the anti-malware application 118a determines that the first process 202a is a known safe process, then the anti-malware application 118a may provide the requesting process 202 with access to the responsive data 204a that includes the data files 120 in the “My Documents” folder 124a. In some embodiments, providing access can include providing access consistent with the privileges of the process. If, for example, the first process 202a is a word processing application that has read and write access to the “My Documents” folder 124a, the anti-malware application 118a may provide the process 202a with read and write access to the data files 120 in the “My Documents” folder 124a. Thus, if a process is determined to be safe, the process 202 may be provided access to data files 120 in a manner that is consistent with its access privileges.

In some embodiments, providing the requesting process with access to honey token data (block 310) can include providing the requesting process 202 with access to honey token data 208 that includes one or more honey tokens 138. For example, the anti-malware application 118a may supply to the requesting process 202, the honey token data 208, or otherwise provide the requesting process 202 with access to the honey token data 208. In some embodiments, the honey token data 208 may include one or more honey tokens 138 and at least a portion of data 204 that is responsive to the access request 200. Thus, the requesting process 202 may be provided access to the honey tokens 138 in place of, or in combination with, the portion of the data 204 that is responsive to the access request 200. In some embodiments, the honey tokens 138 may include pre-stored honey tokens 138 and/or may include dynamically generated honey tokens 138 (e.g., honey tokens 138 generated by the anti-malware application 118a in response to a corresponding access request 200). If, for example, the anti-malware application 118a determines that the third process 202c is an unknown process, the anti-malware application 118a may provide access to the honey token data 208 that includes honey tokens 138 provided in place of, or in combination with, responsive data 204c that includes the data files 120 in the “My Pictures” folder 124c.

In some embodiments, one or more honey tokens 138 can be advanced in a sequence of the honey token data 208 provided in response to an access request 200. If, for example, the user's “My Pictures” file folder 124c includes ten real JPEG files 120, then the honey token data 208 provided in response to the access request 200c may include an enumerated sequence of data including the three false JPEG files (e.g., honey tokens 138), followed by the ten real JPEG files 120 located in the user's “My Pictures” file folder 124c (e.g., the responsive data 204c). That is, the enumerated sequence of data provided in response to the access request 200c may include the following sequence: HT-HT-HT-R-R-R-R-R-R-R-R-R-R, where “HT” represents a honey token image file and “R” represents a real image file (see, e.g., FIG. 4B discussed in more detail below).

In some embodiments, one or more honey tokens 138 can be interspersed (or scattered) within a sequence of the honey token data 208 provided in response to an access request 200. If, for example, the user's “My Pictures” file folder 124c includes ten real JPEG files 120, then the honey token data 208 provided in response to the access request 200c may include an enumerated sequence of data including a first false JPEG file (e.g., a first honey token 138) followed by three of the real JPEG files 120, a second false JPEG file (e.g., a second honey token 138) followed by four of the real JPEG files 120, and a third false JPEG file (e.g., a third honey token 138) followed by the last three of the real JPEG files 120. That is, the enumerated sequence of data provided in response to the access request 200c may include the following sequence: HT-R-R-R-HT-R-R-R-R-HT-R-R-R, where “HT” represents a honey token image file and “R” represents a real image file (see, e.g., FIG. 4C discussed in more detail below).

FIGS. 4A-4C are diagrams that illustrate example honey token data 208 in accordance with one or more embodiments. “HT” may represent a honey token 138 (e.g., a false image file) and “R” may represent real responsive data 204c (e.g., a real image file). FIG. 4A illustrates an example honey token data 208a that includes only three honey tokens 138. FIGS. 4B and 4C illustrate example honey token data 208b and 208c that includes honey tokens 138 provided in combination with responsive data 204c. In FIG. 4B the honey token data 208b may include an enumerated sequence data including the three false JPEG files (e.g., honey tokens 138), followed by the ten real JPEG files 120 located in the user's “My Pictures” file folder 124c (e.g., the responsive data 204c). In FIG. 4C the honey token data 208c may include an enumerated sequence data including the three false JPEG files (e.g., honey tokens 138) interspersed (or scattered) within the ten real JPEG files 120 located in the user's “My Pictures” file folder 124c (e.g., the responsive data 204c).

In some embodiments, the honey tokens 138 can have one or more characteristics (e.g., a type, a name, and/or data) that are expected to entice or bait a malicious process 202 into performing suspicious or malicious activity on the honey tokens 138. In some embodiments, a honey token 138 may include a file of a type that is consistent with (e.g., the same or similar to) the type of data files 120 expected to be responsive to a corresponding access request 200. For example, if an access request 200 requests to access data files 120 in a file folder 124, then a honey token 138 of the honey token data 208 to which access is provided in response to the access request 200 may include a file having a type that is the same or similar to the types of files typically associated with the file folder 124. Continuing with the above examples, the honey token data 208 to which access is provided in response to the access request 200c may include one or more false image files typically associated with users' pictures in a “My Pictures” file folder (e.g., honey token JPEG files, portable document format (PDF) files, tagged image file format (TIFF) files, graphics interchange format (GIF) files, bitmap (BMP) files, raw image format (RAW) files, and/or the like).

In some embodiments, a honey token 138 may include a file of a type that is consistent with (e.g., the same or similar to) the type of data files 120 identified as being responsive to a corresponding access request 200. For example, if an access request 200 requests to access data files 120 in a file folder 124, then a honey token 138 of the honey token data 208 to which access is provided in response to the access request 200 may include a file having a type that is the same or similar to the types of data files 120 located in the file folder 124. Continuing with the above examples, if the “My Pictures” file folder 124c includes only JPEG and TIFF files, then the honey token data 208 to which access is provided in response to the access request 200c may include honey token JPEG files and honey token TIFF files. That is, for example, the honey tokens 138 may have types based on the types of a user's real data files 120 responsive to the access request 200c.

In some embodiments, a honey token 138 may include a file having a name that is consistent with (e.g., the same or similar to) the names of data files 120 expected to be provided in response to an access request 200. For example, if an access request 200 requests access to data files 120 in a file folder 124, then a honey token 138 of the honey token data 208 to which access is provided in response to the access request 200 may include a file having a name that is the same or similar to the names of data files 120 typically found in the folder 124. Continuing with the above example, the honey token data 208 to which access is provided in response to the access request 200c may include one or more false image files (e.g., honey tokens 138) having names that are typically associated with users' photos, such as the files “vacation.jpeg,” “birthday.jpeg,” and/or the like.

In some embodiments, a honey token 138 may include a file having a name that is consistent with (e.g., the same or similar to) the names of real files of the data 204 responsive to the access request 200. For example, if an access request 200 requests access to data files 120 in a file folder 124, then a honey token 138 of the honey token data 208 to which access is provided in response to the access request 200 may include a file having a name that is the same or similar to the names of the data files 120 actually located in the folder 124. Continuing with the above examples, if the “My Pictures” file folder 124c includes the data files 120 of “2012_vacation.jpeg,” “mikes_birthday.jpeg,” and/or the like, then the honey token data 208 to which access is provided in response to the access request 200c may be one or more false image files (e.g., honey tokens 138) named “vacation.jpeg,” “birthday.jpeg,” and/or the like.

In some embodiments, a honey token 138 may include data that is consistent with (e.g., the same or similar to) data expected to be provided in response to an access request 200. For example, if a honey token 138 is a file of a given type, then the honey token file may include data (e.g., strings, values, and/or the like) that is typically associated with the file type and/or that may otherwise be attractive to a malicious process. If, for example, a process 202 submits an access request 200 that requests access to data files 120 of the “My Documents” file folder 124a, then the honey token data 208 to which access is provided in response to the access request 200 may include one or more false files typically associated with users' general documents (e.g., honey token document files, PDF files, TXT files, and/or the like), and those honey token files may include data strings (which are typically found in these types of files), suggesting that the documents are of value to the user, such as “important,” “social security number,” “date of birth,” “confidential,” and/or the like.

In some embodiments, a honey token 138 may include data that is consistent with the portion of the data 204 responsive to the access request 200. For example, a honey token 138 may include data (e.g., strings, values, and/or the like) that is the same or similar to the data in the data files 120 responsive to the access request 200. If, for example, a process 202 submits an access request 200 that requests access to data files 120 of the “My Documents” file folder 124a, which include the text strings “Jane's Recipes,” “Term Paper,” and/or the like, then the honey token data 208 to which access is provided in response to the access request 200 may include one or more false files (e.g., honey tokens 138) typically associated with users' general documents (e.g., honey token document files, PDF files, TXT files, and/or the like), that include the text strings “Jane's Recipes,” “Term Paper,” and/or the like.

In some embodiments, providing the requesting process with access to token data can include backing-up the real data files 120 provided in response to the access request 200. For example, a duplicate copy of the data 204 provided to a process 202 (e.g., in response to a request by an unknown process 202) can be maintained at least until the process 202 is determined to be safe (trusted), or otherwise not suspicious. For example, a duplicate copy of the ten real JPEG files 120 from the “My Pictures” file folder 120c can be stored as a back-up when the process 202c is provided access to honey token data 208 that includes the ten real JPEG files 120. If the process 202c is subsequently determined to be a safe (trusted) process (or it is otherwise determined that the real image files were not harmed), the back-up files 120 can be deleted. If the process 202c is subsequently determined to engage in malicious or otherwise suspicious behavior (e.g., altering or deleting the real image files), the back-up files 120 can be used to restore the real image files 120.

In some embodiments, determining whether the requesting process is engaging in suspicious activity with the token data (block 312) includes monitoring how the requesting process 202 is using or otherwise interacting with the honey tokens 138 to which it is provided access. In some embodiments, it can be determined that a requesting process 202 is engaging in suspicious activity if the requesting process 202 takes an action that is consistent with suspicious malicious behavior, such as attempting to alter or exfiltrate the data of one or more honey tokens 138. Continuing with the above examples, if the anti-malware application 118a provides the process 202c with access to three honey tokens 138 (e.g., three false JPEG images), then the anti-malware application 118a may monitor how the process 202c is interacting with each of the three honey tokens 138. If the monitoring by the anti-malware application 118a detects that the process 202c is attempting to modify (e.g., attempting to edit, encrypt, or delete) at least one of the three honey tokens 138 and/or attempting to exfiltrate data from (e.g., attempting to copy data from) at least one of the three honey tokens 138, then the anti-malware application 118a may determine that the process 202c is engaging in suspicious activity. In some embodiments, the determination of whether the requesting process 202 is engaging in suspicious activity can be based on the application of the behavior rules 134. If, for example, the behavior rules 134 specify that an attempt to encrypt a file by a process 202 is suspicious behavior of a high-threat level, then the anti-malware application 118a may determine that the process 202c is engaging in suspicious activity of a high-threat level if monitoring by the anti-malware application 118a detects that the process 202c is attempting to encrypt one of the honey tokens 138 of the honey token data 208.

In some embodiments, taking remedial action (block 314) can include not enabling access to or otherwise inhibiting access to the portion of the data 204 that is responsive to the access request 200. Taking remedial action may include, for example, notifying a user of the suspicious process (e.g., via an on-screen prompt), suspending or terminating the suspicious process (e.g., suspending execution of the process such that it cannot conduct suspicious or malicious activity on other data), restricting rights of the suspicious process (e.g., restricting the process's access rights to certain types of data), deleting the suspicious process (e.g., removing the process from the system), sandboxing the suspicious process (e.g., isolating the execution environment of the process), backing-up potentially vulnerable files (e.g., backing-up files that are the same or similar to those attempting to be accessed by the process), and/or the like.

If, for example, the anti-malware application 118a determines that the second process 202b is a known unsafe process, the anti-malware application 118a may block the requesting process 202 from having access to responsive data 204b that includes the data files 120 in the “My Music” folder 124b. Further, the anti-malware application 118a may proceed to generate an on-screen prompt notifying a user of the presence of the known unsafe process 202b (e.g., via an on-screen prompt displayed by the computer system 102), suspend or terminate the known unsafe process 202b, and delete the known unsafe process 202b and related elements from the computer system 102 (e.g., uninstall the gaming application associated with the process 202b).

If, for example, the anti-malware application 118a determines that the process 202c is engaging in suspicious activity, then the anti-malware application 118a may restrict the process's access to the portion of the data 204 that is responsive to the third request 200c (e.g., the anti-malware application 118a may block the processes 202c from accessing responsive data 204c that includes the data files 120 in the “My Pictures” folder 124c). Further, the anti-malware application 118a may proceed to generate an on-screen prompt notifying a user of the presence of the suspicious process 202c (e.g., via an on-screen prompt displayed by the computer system 102), suspend or terminate the process 202c, and delete the process 202c (e.g., uninstall the media player application associated with the process 202c) from the computer system 102.

In some embodiments, the determination of the type of remedial action can be based on the application of the remedial rules 136. If, for example, the remedial rules 136 specify that if suspicious behavior is classified as a high threat, then the offending process should be deleted from the system. If it is determined that the process 202c is engaging in suspicious activity of a high-threat level (e.g., the process 202c is attempting to encrypt one of the honey tokens 138 of the honey token data 208), then the anti-malware application 118a may take remedial action that includes deleting the process 202c and related elements from the computer system 102 (e.g., uninstall the media player application associated with the process 202c).

In some embodiments, taking remedial action can include updating the unsafe list 132. If, for example, it is determined that the process 202c is engaging in suspicious activity (e.g., the process 202c is attempting to encrypt one of the honey tokens 138 of the honey token data 208), then the anti-malware application 118a may update the unsafe list 132 to include the process 202c and the media player application that is associated with the process 202c.

In some embodiments, taking remedial action can include taking similar steps with regard to any other elements (e.g., processes or applications) associated with a process 202 that is engaging in suspicious activity, including those on the local computer system 102 and/or other computer systems 102. If for example, it is determined that the process 202c is engaging in suspicious activity (e.g., the process 202c is attempting to encrypt one of the honey tokens 138 of the honey token data 208), then the anti-malware application 118a may proceed to suspend one or more other processes 202 that are related to the process 202c (e.g., suspending other processes 202 associated with the media player application that is associated with the process 202c), and/or may cause an alert to be sent to another computer system 102 (e.g., an anti-malware server that is tracking the proliferation of malware). In such an embodiment, the anti-malware server may broadcast information about the offending process 202c to other computer systems 102. For example, the anti-malware server may broadcast an updated unsafe list 132 that includes the process 202c and the media player application that is associated with the process 202c. In some embodiments, the anti-malware server may broadcast various types of updated malware information to clients. For example, the anti-malware server may broadcast an updated unsafe list 132, an updated safe list 130, updated remedial rules 136 and/or updated behavior rules 134. For example, if a process is on the safe list 130 and is not on the unsafe list 132, but is found to be malware, the server may generate and broadcast to one or more client devices (e.g., broadcast to other computer system 102 via the network 106) an updated version of the safe list 130 that does not include the process, and/or an updated version of the unsafe list 132 that does include the process. As a further example, in response to updating the remedial rules 136 and/or the behavioral rules 134 (e.g., based on processes determined as safe or unsafe and/or observed/detected malicious activity by one or more processes), the server may generate and broadcast to one or more client devices an updated version of the remedial rules 136 (e.g., that define an updated set of remedial actions), and/or an updated version of the behavioral rules 134 (e.g., that define an updated set of behavioral rules). The client devices may, for example, use the broadcast information until they receive the next updated version. Thus, the client devices may be provided with and make use of current/updated versions unsafe lists 132, safe lists 130, remedial rules 136 and/or behavior rules 134.

It will be appreciated that the method 300 is an example embodiment of methods that may be employed in accordance with the techniques described herein. The method 300 may be modified to facilitate variations of implementations and uses. The order of the method 300 and the operations provided therein may be changed, and various elements may be added, reordered, combined, omitted, modified, etc. Portions of the method 300 may be implemented in software, hardware, or a combination thereof. Some or all of the portions of the method 300 may be implemented by one or more of the processors/modules/applications described herein.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features of the embodiments may be utilized independently, all as would be apparent to one skilled in the art after having the benefit of this description of the embodiments. Changes may be made in the elements described herein without departing from the spirit and scope of the embodiments as described in the following claims. Headings used herein are for organizational purposes only and are not meant to be used to limit the scope of the description.

In an example embodiment, provided is a system including a processor, and a memory including program instructions executable by the processor to receive, from a process, a request to access data, determine that the process is an unknown process, in response to determining that the process is an unknown process, providing the process with access to one or more data tokens, determine whether the process is engaging in suspicious activity with the one or more data tokens, and inhibit, in response to determining that the process is engaging in suspicious activity with the one or more data tokens, execution of the process.

The request to access data can include a request to access data files, and where the one or more data tokens comprise false data files. Providing the process with access to the one or more data tokens can include providing the one or more data tokens in place of data responsive to the request. Providing the process with access to the one or more data tokens can include providing the one or more data tokens along with data responsive to the request. Providing the one or more data tokens along with data responsive to the request can include providing an enumerated sequence of data, wherein the one or more data tokens are provided at the beginning of the enumerated sequence of data. Providing the one or more data tokens along with data responsive to the request can include providing an enumerated sequence of data, wherein the one or more data tokens are interspersed in the enumerated sequence of data. Determining that the process is an unknown process can include determining that the process is not identified as a trusted process. Engaging in suspicious activity with the one or more data tokens can include attempting to alter the one or more data tokens. Engaging in suspicious activity with the one or more data tokens can include attempting to exfiltrate data of the one or more data tokens. Inhibiting execution of the process can include at least one of the following: suspending the process, terminating the process, or deleting the process. The request to access data can include a request to access data files in a file folder, and the one or more data tokens can include false data files comprising a name that is the same or similar to the names of real files in the file folder. The request to access data can include a request to access data files in a file folder, and the one or more data tokens can include false data files of a type that is the same or similar to the types of real files in the file folder. The request to access data can include a request to access data files in a file folder, and the one or more data tokens can include false data files that can include data that is the same or similar to data contained in real files in the file folder. The program instructions can be further executable to receive, via broadcast by a server, a safe list and an unsafe list. The safe list may identify one or more processes known to be free of any association with malware, the unsafe list may identify one or more processes known to be associated with malware, and determining that the process is an unknown process can include determining that the process is not listed on the safe list and is not listed on the unsafe list. The program instructions can be further executable to receive, via broadcast by a server, an updated set of remedial rules. The remedial rules may define one or more actions to inhibit execution of a process, and inhibiting execution of the process can be performed in accordance with the updated set of remedial rules.

In an example embodiment, provided is a method that includes receiving, from a process, a request to access data, determining that the process is an unknown process, in response to determining that the process is an unknown process, providing the process with access to one or more data tokens, determine whether the process is engaging in suspicious activity with the one or more data tokens, and inhibit, in response to determining that the process is engaging in suspicious activity with the one or more data tokens, execution of the process.

The request to access data can include a request to access data files, and where the one or more data tokens comprise false data files. Providing the process with access to the one or more data tokens can include providing the one or more data tokens in place of data responsive to the request. Providing the process with access to the one or more data tokens can include providing the one or more data tokens along with data responsive to the request. Providing the one or more data tokens along with data responsive to the request can include providing an enumerated sequence of data, wherein the one or more data tokens are provided at the beginning of the enumerated sequence of data. Providing the one or more data tokens along with data responsive to the request can include providing an enumerated sequence of data, wherein the one or more data tokens are interspersed in the enumerated sequence of data. Determining that the process is an unknown process can include determining that the process is not identified as a trusted process. Engaging in suspicious activity with the one or more data tokens can include attempting to alter the one or more data tokens. Engaging in suspicious activity with the one or more data tokens can include attempting to exfiltrate data of the one or more data tokens. Inhibiting execution of the process can include at least one of the following: suspending the process, terminating the process, or deleting the process. The request to access data can include a request to access data files in a file folder, and the one or more data tokens can include false data files comprising a name that is the same or similar to the names of real files in the file folder. The request to access data can include a request to access data files in a file folder, and the one or more data tokens can include false data files of a type that is the same or similar to the types of real files in the file folder. The request to access data can include a request to access data files in a file folder, and the one or more data tokens can include false data files that can include data that is the same or similar to data contained in real files in the file folder. The method may further include receiving, via broadcast by a server, a safe list and an unsafe list. The safe list may identify one or more processes known to be free of any association with malware, the unsafe list may identify one or more processes known to be associated with malware, and determining that the process is an unknown process can include determining that the process is not listed on the safe list and is not listed on the unsafe list. The method may further include receiving, via broadcast by a server, an updated set of remedial rules. The remedial rules may define one or more actions to inhibit execution of a process, and inhibiting execution of the process can be performed in accordance with the updated set of remedial rules.

In an example embodiment, a means may be provided for performing some or all of the elements of method described above.

In an example embodiment, provided is a non-transitory computer-readable storage medium having computer-executable program instructions stored thereon that are executable by a computer to receive, from a process, a request to access data, determine that the process is an unknown process, in response to determining that the process is an unknown process, providing the process with access to one or more data tokens, determine whether the process is engaging in suspicious activity with the one or more data tokens, and inhibit, in response to determining that the process is engaging in suspicious activity with the one or more data tokens, execution of the process.

The request to access data can include a request to access data files, and where the one or more data tokens comprise false data files. Providing the process with access to the one or more data tokens can include providing the one or more data tokens in place of data responsive to the request. Providing the process with access to the one or more data tokens can include providing the one or more data tokens along with data responsive to the request. Providing the one or more data tokens along with data responsive to the request can include providing an enumerated sequence of data, wherein the one or more data tokens are provided at the beginning of the enumerated sequence of data. Providing the one or more data tokens along with data responsive to the request can include providing an enumerated sequence of data, wherein the one or more data tokens are interspersed in the enumerated sequence of data. Determining that the process is an unknown process can include determining that the process is not identified as a trusted process. Engaging in suspicious activity with the one or more data tokens can include attempting to alter the one or more data tokens. Engaging in suspicious activity with the one or more data tokens can include attempting to exfiltrate data of the one or more data tokens. Inhibiting execution of the process can include at least one of the following: suspending the process, terminating the process, or deleting the process. The request to access data can include a request to access data files in a file folder, and the one or more data tokens can include false data files comprising a name that is the same or similar to the names of real files in the file folder. The request to access data can include a request to access data files in a file folder, and the one or more data tokens can include false data files of a type that is the same or similar to the types of real files in the file folder. The request to access data can include a request to access data files in a file folder, and the one or more data tokens can include false data files that can include data that is the same or similar to data contained in real files in the file folder. The program instructions can be further executable to receive, via broadcast by a server, a safe list and an unsafe list. The safe list may identify one or more processes known to be free of any association with malware, the unsafe list may identify one or more processes known to be associated with malware, and determining that the process is an unknown process can include determining that the process is not listed on the safe list and is not listed on the unsafe list. The program instructions can be further executable to receive, via broadcast by a server, an updated set of remedial rules. The remedial rules may define one or more actions to inhibit execution of a process, and inhibiting execution of the process can be performed in accordance with the updated set of remedial rules.

In an example embodiment, provided is a non-transitory computer-readable storage medium having computer-executable program instructions stored thereon that are executable by a computer to receive, from one or more client devices, malware data indicative of one or more malicious processes, generate, based at least in part on the malware data, a set of remedial rules defining remedial actions to be taken in response to determining that a process is engaging in a manner that indicates an association with malware, and send, to one or more client devices, the set of remedial rules.

The program instructions can be further executable to generate, based at least in part on the malware data, at least one of a safe list, an unsafe list, or a set of behavioral rules, and send, to one or more client devices, the at least one of a safe list, an unsafe list, or a set of behavioral rules. The safe list can identify one or more processes known to be free of any association with malware, the unsafe list can identify one or more processes known to be associated with malware, and the set of behavioral rules including rules for identifying processes associated with malware.

In an example embodiment, provided is a system, that includes a processor, and a memory comprising program instructions executable by the processor to receive, from one or more client devices, malware data indicative of one or more malicious processes, generate, based at least in part on the malware data, a set of remedial rules defining remedial actions to be taken in response to determining that a process is engaging in a manner that indicates an association with malware, and send, to one or more client devices, the set of remedial rules.

The program instructions can be further executable to generate, based at least in part on the malware data, at least one of a safe list, an unsafe list, or a set of behavioral rules, and send, to one or more client devices, the at least one of a safe list, an unsafe list, or a set of behavioral rules. The safe list can identify one or more processes known to be free of any association with malware, the unsafe list can identify one or more processes known to be associated with malware, and the set of behavioral rules including rules for identifying processes associated with malware.

As used throughout this application, the word “may” is used in a permissive sense (i.e., meaning having the potential to), rather than the mandatory sense (i.e., meaning must). The words “include,” “including,” and “includes” mean including, but not limited to. As used throughout this application, the singular forms “a”, “an,” and “the” include plural referents unless the content clearly indicates otherwise. Thus, for example, reference to “an element” may include a combination of two or more elements. As used throughout this application, the phrase “based on” does not limit the associated operation to being solely based on a particular item. Thus, for example, processing “based on” data A may include processing based at least in part on data A and based at least in part on data B unless the content clearly indicates otherwise. As used throughout this application, the term “from” does not limit the associated operation to being directly from. Thus, for example, receiving an item “from” an entity may include receiving an item directly from the entity or indirectly from the entity (e.g., via an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

What is claimed is:

1. A non-transitory computer-readable storage medium having computer-executable program instructions stored thereon that are executable by a computer to:
receive, from a process, a request to access data;
determine that the process is an unknown process;
in response to determining that the process is an unknown process, provide the process with access to one or more data tokens;
determine whether the process is engaging in suspicious activity with the one or more data tokens; and
inhibit, in response to determining that the process is engaging in suspicious activity with the one or more data tokens, execution of the process.

2. The medium of claim 1, wherein the request to access data comprises a request to access data files, and wherein the one or more data tokens comprise false data files.

3. The medium of claim 1, wherein providing the process with access to the one or more data tokens comprises providing the one or more data tokens in place of data responsive to the request.

4. The medium of claim 1, wherein providing the process with access to the one or more data tokens comprises providing the one or more data tokens along with data responsive to the request.

5. The medium of claim 4, wherein providing the one or more data tokens along with data responsive to the request comprises providing an enumerated sequence of data, wherein the one or more data tokens are provided at the beginning of the enumerated sequence of data.

6. The medium of claim 4, wherein providing the one or more data tokens along with data responsive to the request comprises providing an enumerated sequence of data, wherein the one or more data tokens are interspersed in the enumerated sequence of data.

7. The medium of claim 1, wherein determining that the process is an unknown process comprises determining that the process is not identified as a trusted process.

8. The medium of claim 1, wherein engaging in suspicious activity with the one or more data tokens comprises attempting to alter the one or more data tokens or exfiltrate data of the one or more data tokens.

9. The medium of claim 1, wherein engaging in suspicious activity with the one or more data tokens comprises attempting to exfiltrate data of the one or more data tokens.

10. The medium of claim 1, wherein inhibiting execution of the process comprises at least one of the following: suspending the process, terminating the process, or deleting the process.

11. The medium of claim 1, wherein the program instructions are further executable to:
receive, via broadcast by a server, a safe list and an unsafe list, wherein the safe list identifies one or more processes known to be free of any association with malware, wherein the unsafe list identifies one or more processes known to be associated with malware, and
wherein determining that the process is an unknown process comprises determining that the process is not listed on the safe list and is not listed on the unsafe list.

12. The medium of claim 1, wherein the program instructions are further executable to:
receive, via broadcast by a server, an updated set of remedial rules, wherein the remedial rules define one or more actions to inhibit execution of a process; and
wherein inhibiting execution of the process is performed in accordance with the updated set of remedial rules.

13. A system, comprising:
a processor; and
a memory comprising program instructions executable by the processor to:
receive, from a process, a request to access data;
determine that the process is an unknown process;
in response to determining that the process is an unknown process, provide the process with access to one or more data tokens;
determine whether the process is engaging in suspicious activity with the one or more data tokens; and
inhibit, in response to determining that the process is engaging in suspicious activity with the one or more data tokens, execution of the process.

14. The system of claim 13, wherein the request to access data comprises a request to access data files, and wherein the one or more data tokens comprise false data files.

15. The system of claim 13, wherein providing the process with access to the one or more data tokens comprises providing the one or more data tokens in place of data responsive to the request.

16. The system of claim 13, wherein providing the process with access to the one or more data tokens comprises providing the one or more data tokens along with data responsive to the request.

17. The system of claim 16, wherein providing the one or more data tokens along with data responsive to the request comprises providing an enumerated sequence of data, wherein the one or more data tokens are interspersed in the enumerated sequence of data.

18. The system of claim 13, wherein engaging in suspicious activity with the one or more data tokens comprises attempting to alter the one or more data tokens or exfiltrate data of the one or more data tokens.

19. The system of claim 13, wherein inhibiting execution of the process comprises at least one of the following: suspending the process, terminating the process, or deleting the process.

20. A method for remediating malware, the method comprising:
receiving, from a process, a request to access data;
determining that the process is an unknown process;
in response to determining that the process is an unknown process, providing the process with access to one or more data tokens;
determining whether the process is engaging in suspicious activity with the one or more data tokens; and
inhibiting, in response to determining that the process is engaging in suspicious activity with the one or more data tokens, execution of the process.

21. The method of claim 20, wherein the request to access data comprises a request to access data files, and wherein the one or more data tokens comprise false data files.

22. A non-transitory computer-readable storage medium having computer-executable program instructions stored thereon that are executable by a computer to:
receive, from one or more client devices, malware data indicative of one or more malicious processes;
generate, based at least in part on the malware data, a set of remedial rules defining remedial actions to be taken in response to determining that a process is engaging in a manner that indicates an association with malware; and
send, to one or more client devices, the set of remedial rules.

23. The medium of claim 22, wherein the program instructions are further executable to:
generate, based at least in part on the malware data, at least one of a safe list, an unsafe list, or a set of behavioral rules, wherein the safe list identifies one or more processes known to be free of any association with malware, wherein the unsafe list identifies one or more processes known to be associated with malware, and wherein the set of behavioral rules include rules for identifying processes associated with malware; and
send, to one or more client devices, the at least one of a safe list, an unsafe list, or a set of behavioral rules.

24. A system, comprising:
a processor; and
a memory comprising program instructions executable by the processor to:
receive, from one or more client devices, malware data indicative of one or more malicious processes;
generate, based at least in part on the malware data, a set of remedial rules defining remedial actions to be taken in response to determining that a process is engaging in a manner that indicates an association with malware; and
send, to one or more client devices, the set of remedial rules.

25. The system of claim 24, wherein the program instructions are further executable to:
generate, based at least in part on the malware data, at least one of a safe list, an unsafe list, or a set of behavioral rules, wherein the safe list identifies one or more processes known to be free of any association with malware, wherein the unsafe list identifies one or more processes known to be associated with malware, and wherein the set of behavioral rules include rules for identifying processes associated with malware; and
send, to one or more client devices, the at least one of a safe list, an unsafe list, or a set of behavioral rules.
